(19) United States
(12) Patent Application Publication
(10) Pub. No.: US 2009/0282744 A1
(43) Pub. Date: Nov. 19, 2009

(54) Window driving apparatus

(75) Inventor: Ok Tae JUNG, Gwacheon-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); PYEONG HWA AUTOMOTIVE CO., LTD., Daegu (KR)

(21) Appl. No.: 12/325,125

(22) Filed: Nov. 28, 2008

(30) Foreign Application Priority Data
May 19, 2008 (KR) 10-2008-0046217

(51) Int. Cl. B60J 5/00

(52) U.S. Cl. 49/502

(57) ABSTRACT

A window driving apparatus includes a door module panel, which is made of plastic and is mounted to an inner panel of a door. A rail is integrally provided on one surface of the door module panel. The rail extends a predetermined length in a direction in which a window is moved upwards or downwards. The apparatus further includes a carrier plate, which is slidably coupled to the rail of the door module panel and supports the lower end of the window, and a regulator, which moves a wire connected to the carrier plate such that the carrier plate is moved upwards or downwards along the rail. In the window driving apparatus according to the present invention, the door module panel and the rail are integrally formed into a single body using plastic.

### CROSS-REFERENCE TO RELATED APPLICATION

The present application claims priority to Korean Patent Application Number 10-2008-0046217 filed May 19, 2008, the entire contents of which application is incorporated herein for all purposes by this reference.

### BACKGROUND OF THE INVENTION

1. Field of the Invention

The present invention relates generally to window driving apparatuses and, more particularly, to a window driving apparatus which has a carrier plate and a regulator and is mounted to an inner panel of a door to move a window upwards or downwards.

2. Description of Related Art

As well known to those skilled in the art, vehicle windows are provided between inner and outer panels of vehicles doors and are selectively moved upwards or downwards. To move such a window upwards or downwards, a door module panel is mounted to an inner panel of a door. Several actuating members for supporting the window and moving it upwards or downwards are provided on the door module panel. Furthermore, attachments, such as a speaker, a latch unit, etc., are installed on the door module panel

A window driving apparatus 30 according to a conventional technique will be explained in detail with reference to FIGS. 1 and 2. The window driving apparatus 30 includes a door module panel 10, a rail 32, which is provided on the door module panel 10, and a carrier plate 34, which is coupled to the rail 32. The carrier plate 34 is moved upwards or downwards by a wire 36 and a regulator 38. The wire 36 is fastened at the opposite ends thereof to the carrier plate 34 and is moved upwards or downwards by the regulator 38. Rollers 37 and 37′, which guide the movement of the wire 36, are provided on the rail 32. Thus, the carrier plate 34 slides along the rail 32 by the movement of the wire 36

The carrier plate 34 supports the lower end of the window. Hence, when the carrier plate 34 is moved upwards, the window is raised. When the carrier plate 34 is moved downwards, the window is lowered

For reference, a door speaker 50 and a door latch unit 70 are provided on the door module panel 10 of the window driving apparatus 30.

In the conventional window driving apparatus 30 having the above-mentioned construction, the rail 32 and the door module panel 10 are manufactured through separate processes. The rail 32 is attached at the opposite ends thereof to the door module panel 10 using bolts or rivets 33 and 33′. The carrier plate 34 is thereafter coupled to the rail 32, which are attached to the door module panel 10

As such, because the rail is manufactured through a separate process different from that of the door module panel and is thereafter attached to the door module panel, the manufacturing costs are increased and working time and effort are increased

Furthermore, the door module panel and the rail are made of steel, so that the manufacturing costs are further increased and the weight of the door is increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a window driving apparatus in which a door module panel and a rail are integrally formed into a single body so that the manufacturing costs and working time and effort are reduced, and in which the door module panel and the rail to be integrated with each other are made of material that can be easily shaped and is relatively light.

In one aspect of the present invention, a window driving apparatus may include a door module panel being mounted to an inner panel of a door and including a rail monolithically provided on an upper surface of the door module panel, the rail extending with a predetermined length in a direction in which a window is moved upwards or downwards, a carrier plate slidably coupled to the rail of the door module panel so as to move along the rail, wherein the carrier plate supports a lower end of the window, and/or a regulator to move a wire connected to both ends of the carrier plate such that the carrier plate is moved upwards or downwards along the rail.

The door module panel may be made of plastic, wherein the plastic is polypropylene (PP) having a weight ratio ranging from approximately 50% to approximately 80% and long glass fiber (LGF) having a weight ratio ranging from approximately 20% to approximately 50%.

The rail may be made of plastic, wherein the plastic is polypropylene (PP) having a weight ratio ranging from approximately 50% to approximately 80% and long glass fiber (LGF) having a weight ratio ranging from approximately 20% to approximately 50%.

The rail may be disposed substantially on a central portion of the door module panel in a horizontal direction and extends in a vertical direction with the predetermined distance.

The rail may protrude upwards from the upper surface of the door module panel by a predetermined distance and is slidably coupled to the carrier plate.

The carrier plate may be fitted over the rail through a guide slot formed at a lower portion of the carrier plate to receive upper end of the rail, wherein the carrier plate is prevented from being removed from the rail by a stop portion configured to be bent from the upper end of the rail.

A first end of the rail may be open structure, so that the carrier plate can be mounted to the door module panel by simply sliding through the first end of the rail.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a front view showing a window driving apparatus, according to a conventional technique.

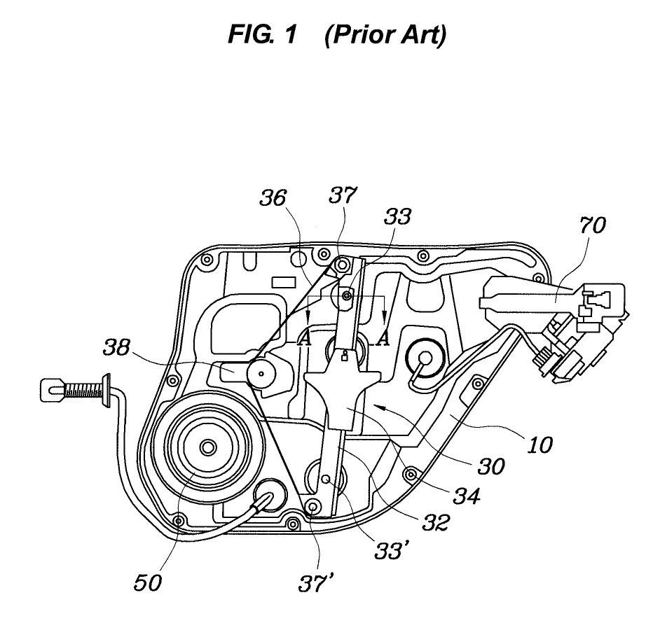

FIG. 2 is a sectional view taken along the line A-A of FIG. 1 showing the conventional window driving apparatus.

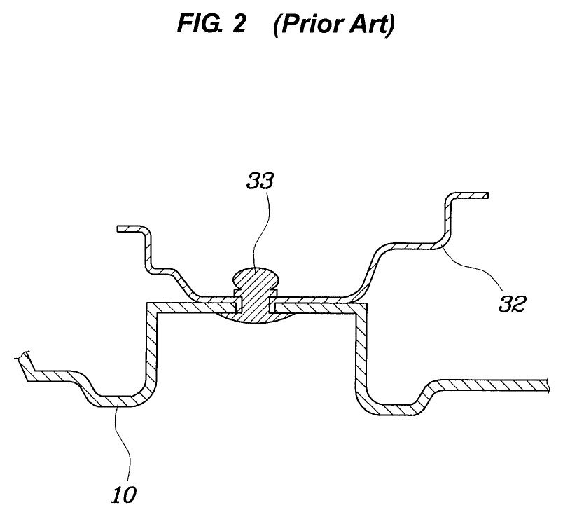

FIG. 3 is a front view of an exemplary window driving apparatus according to the present invention.

FIG. 4 is a sectional view taken along the line B-B of FIG. 3 showing the exemplary window driving apparatus according to the present invention.

FIG. 5 is a perspective view of a first end of the rail of FIG. 3 showing the exemplary window driving apparatus according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

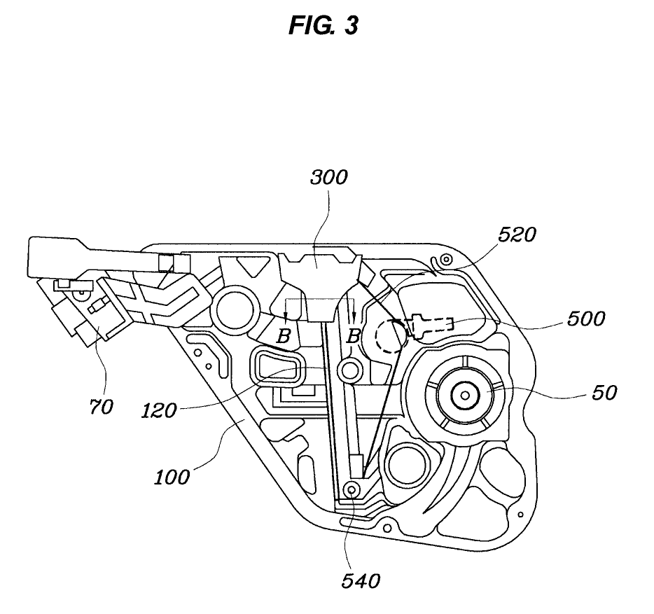

FIG. 3 is a front view of a window driving apparatus, according to various embodiments of the present invention. The construction of the window driving apparatus will be explained in detail with reference to FIG. 3.

The window driving apparatus of the present invention includes a door module panel 100, which is made of plastic and is mounted to an inner panel of a door. A rail 120, which extends a predetermined length in a direction in which a window is raised or lowered, is integrally provided on one surface of the door module panel 100. One will appreciate that the rail may be monolithically formed with the door module panel. The window driving apparatus further includes a carrier plate 300, which supports the lower end of the window and is coupled to the rail 120 so as to be slidable, and a regulator 500, which moves a wire 520 connected to the carrier plate 300 such that the carrier plate 300 is raised or lowered along the rail 120.

The door module panel 100 and the rail 120 are made of plastic and are formed into a single body. Thus, the manufacturing costs and working time and effort are reduced, compared to the conventional method in which the door module panel and the rail are manufactured through separate processes and are coupled to each other using bolts or rivets. In addition, the weight of the door is reduced, so that the operability of the door is increased and it becomes easy to integrally form the door module panel 100 and the rail 120 into a single body.

For example, polypropylene (PP) having a weight ratio ranging from 50% to 80% and long glass fiber (LGF) having a weight ratio ranging from 20% to 50% are preferably used as plastic for the door module panel 100 and the rail 120. In the case where polypropylene is less than 50 wt %, the plasticity is reduced. In the case where polypropylene is greater than 80 wt %, the strength is reduced.

Meanwhile, a door speaker 50 or a latch unit 70 may be installed on the door module panel 100 of the window driving apparatus.

In various embodiments of the present invention, several pairs of rails 120 and carrier plates 300 may be provided, but it is preferable that the single rail 120 be provided on the central portion of the door module panel 100 in the vertical direction. The reason for this is that even though only the single rail 120 and the single carrier plate 300 are provided on the door module panel 100, the window can still be reliably moved upwards or downwards. Furthermore, in the case where the single rail 120 and the single the carrier plate 300 are provided, when they are disposed on the central portion of the door module panel 100, the stability thereof can be ensured.

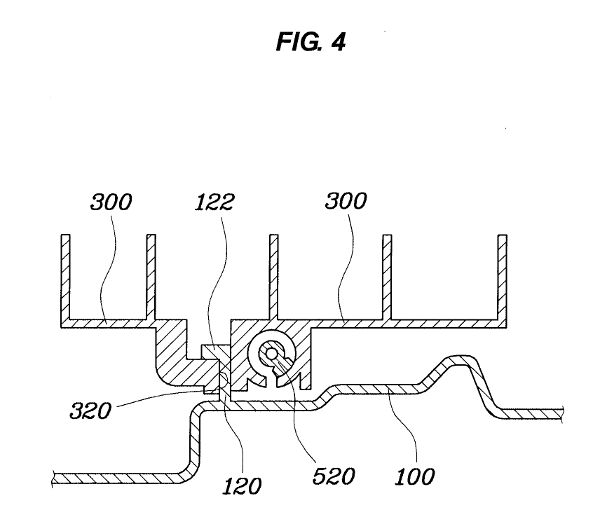

The coupling relationship between the rail 120 and the carrier plate 300 will be described with reference to FIG. 4.

The rail 120, which extends a predetermined length in the vertical direction, perpendicularly protrudes from the door module panel 100. The carrier plate 300 is fitted over the rail 120 through a guide slot 320 formed at a lower portion of the carrier plate 300 to receive upper end of the rail 120. The carrier plate 300 is prevented from being removed from the rail 120 by a stop portion 122 configured to be bent from the upper end of the rail 120. The stop portion 122 may have a structure such that it is bent from the upper end of the rail 120 in one direction to receive the carrier plate 300 therein, as shown in the drawing. Alternatively, the stop portion 122 may have a structure such that it extends from the edge of the rail 120 in opposite directions. The carrier plate 300 is seated onto the rail 120 through the guide slot 320 so as to be vertically slidable along the rail 120. The stop portion 122, which is formed on the edge of the rail 120, functions to prevent the carrier plate 300 from being undesirably removed from the rail 120 when the carrier plate 300 slides along the rail 120.

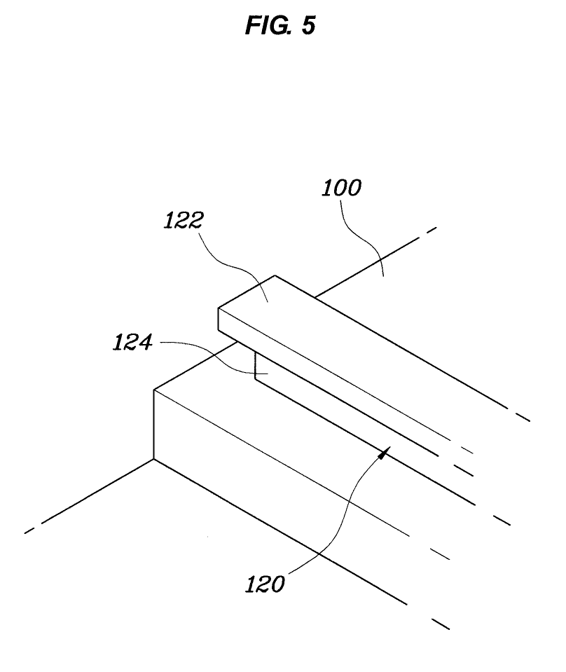

Referring to FIG. 5, a first end of the rail 124 is open structure, so that the carrier plate 300 can be mounted to the door module panel 100 by simply sliding through the first end of the rail 124. After the carrier plate 300 is mounted to the door module panel 100, the carrier plate 300 is able to move along the rail 120 by the wire 520, and the carrier plate 300 is prevented from being slipped out of the first end of the rail 124 by tension provided from the wire 520.

The lower end of the window is supported by the upper end of the carrier plate 300. The opposite ends of the wire 520 are coupled to the carrier plate 300. Roller 540 is positioned on the door module panel 100 and configured to change movement direction of the wire 520. The regulator 500 is mounted to the door module panel 100 and moves the wire 520 upwards or downwards using a motor. The carrier plate 300 is pulled by the wire 520 and moves along the rail 120 upwards or downwards, thus moving the window upwards or downwards.

As described above, the present invention provides a window driving apparatus, in which a door module panel and a rail are integrally formed with each other and are made of plastic. Therefore, the number of elements of the apparatus and the working time and effort are reduced. Furthermore, the weight of the apparatus is reduced. Unlike the conventional technique having the complex structure, the present invention has a simple structure, and a process of forming it can be simplified. Accordingly, the manufacturing costs can be reduced.

For convenience in explanation and accurate definition in the appended claims, the terms “up” or “upper”, “down” or “lower”, “front” or “rear”, “inside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A window driving apparatus, comprising:
a door module panel being mounted to an inner panel of a door and including a rail monolithically provided on an upper surface of the door module panel, the rail extending with a predetermined length in a direction in which a window is moved upwards or downwards;
a carrier plate slidably coupled to the rail of the door module panel so as to move along the rail, wherein the carrier plate supports a lower end of the window; and
a regulator to move a wire connected to both ends of the carrier plate such that the carrier plate is moved upwards or downwards along the rail.

2. The window driving apparatus as set forth in claim 1, wherein the door module panel is made of plastic.

3. The window driving apparatus as set forth in claim 1, wherein the plastic is polypropylene (PP) having a weight ratio ranging from approximately 50% to approximately 80% and long glass fiber (LGF) having a weight ratio ranging from approximately 20% to approximately 50%.

4. The window driving apparatus as set forth in claim 1, wherein the rail is made of plastic.

5. The window driving apparatus as set forth in claim 4, wherein the plastic is polypropylene (PP) having a weight ratio ranging from approximately 50% to approximately 80% and long glass fiber (LGF) having a weight ratio ranging from approximately 20% to approximately 50%.

6. The window driving apparatus as set forth in claim 1, wherein the rail is disposed substantially on a central portion of the door module panel in a horizontal direction and extends in a vertical direction with the predetermined distance.

7. The window driving apparatus as set forth in claim 1, wherein the rail protrudes upwards from the upper surface of the door module panel by a predetermined distance and is slidably coupled to the carrier plate.

8. The window driving apparatus as set forth in claim 1, wherein the carrier plate is fitted over the rail through a guide slot formed at a lower portion of the carrier plate to receive upper end of the rail.

9. The window driving apparatus as set forth in claim 8, wherein the carrier plate is prevented from being removed from the rail by a stop portion configured to be bent from the upper end of the rail.

10. The window driving apparatus as set forth in claim 9, wherein a first end of the rail is open structure, so that the carrier plate can be mounted to the door module panel by simply sliding through the first end of the rail.

11. A passenger vehicle comprising of the window driving apparatus as set forth in claim 1.
